(19) United States
(12) Patent Application Publication
(10) Pub. No.: US 2025/0197211 A1
(43) Pub. Date: Jun. 19, 2025

(54) SYSTEMS AND METHODS FOR PRODUCING HYDROGEN GAS USING FLUIDIZED-BED REACTOR

(71) Applicant: The Babcock & Wilcox Company, Akron, OH (US)

(72) Inventors: James F. DeSellem, Salineville, OH (US); Karl M. Heil, North Canton, OH (US); Kevin A. Larson, Clinton, OH (US); Luis G. Velazquez-Vargas, Copley, OH (US); Thomas J. Flynn, North Canton, OH (US)

(21) Appl. No.: 18/540,674

(22) Filed: Dec. 14, 2023

(51) Int. Cl. C01B 3/34; B01J 8/00; B01J 8/18; B01J 8/26; B01J 8/36; B01J 8/38

(52) U.S. Cl. CPC C01B 3/344; B01J 8/003; B01J 8/005; B01J 8/1881; B01J 8/26; B01J 8/36; B01J 8/38; C01B 2203/0255; C01B 2203/0272; C01B 2203/0283; C01B 2203/0415; C01B 2203/148

(57) ABSTRACT

Chemical looping systems and methods for producing hydrogen gas are described herein that use a fluidized-bed reactor to reduce carrier particles; and a moving-bed hydrogen reactor to oxidize the reduced carrier particles and form hydrogen gas. Also possibly included as a cooler for cooling the oxidized carrier particles; and a silo for storing the oxidized carrier particles and feeding them to the fluidized-bed reactor and other components. Various configurations of these components are disclosed herein.

### BACKGROUND

The present disclosure relates to a system that uses chemical looping to produce hydrogen gas. The system includes a fluidized-bed reactor and a hydrogen reactor. Also included are possibly a cooler and a silo, along with other assorted components. Metal oxide particles are reduced and oxidized in a loop within the system. Methods for using such a system to produce energy and other products are also included herein.

Without being bound to any one definition, chemical-looping technologies are technologies that do not use “free” oxygen, but make use of one or more metallic oxygen carriers, or catalysts to transfer the oxidizing agent to a fuel for full or partial conversion. An oxidized metallic oxygen carrier is typically transferred to a fuel reactor, where a fuel is used to reduce the oxygen carrier. The gaseous product of the fuel reactor is generally a mixture of steam and carbon dioxide (CO₂), which can be treated downstream and sequestered or utilized. Chemical looping processes are being developed worldwide as alternative methods to produce hydrogen, syngas, steam, heat and power. Systems for the chemical looping of coal, natural gas, oil, biomass and other hydrocarbon fuels are being developed as well.

### BRIEF DESCRIPTION

The present disclosure relates to chemical looping systems that use a fluidized-bed reactor and a hydrogen reactor to produce hydrogen (H₂) gas and other related products. The systems can use a variety of biomass, waste biomass, or other materials as fuel.

Disclosed in some embodiments are systems, comprising: a fluidized-bed reactor in which carrier particles are reduced; and a hydrogen reactor with a steam inlet, in which the reduced carrier particles are oxidized and hydrogen gas is formed.

In some embodiments, the system can further comprise a silo configured to feed the oxidized carrier particles to the fluidized-bed reactor.

The system can also further comprise a cooler in which the oxidized carrier particles are cooled. Sometimes, the cooler can produce steam that is fed to the steam inlet of the hydrogen reactor.

In further embodiments, the system may further comprise a hopper upstream of the hydrogen reactor, which is adapted to receive the reduced carrier particles from the fluidized-bed reactor. The fluidized-bed reactor and the hopper sometimes can be located within a furnace. The system may also further comprise a heater downstream of the hopper and upstream of the hydrogen reactor, which is adapted to reheat the reduced carrier particles.

In particular embodiments, the fluidized-bed reactor is a bubbling fluidized-bed reactor or a circulating fluidized-bed reactor.

A flue gas from the fluidized-bed reactor may pass through a water-gas shift unit and a pressure-swing adsorption unit to produce another hydrogen stream.

In other embodiments, the system can further comprise a gas-solid separator for separating reduced carrier particles entrained in a flue gas leaving the fluidized-bed reactor, wherein the reduced carrier particles pass to the hydrogen reactor. The gas-solid separator may comprise u-beams or a cyclone. A flue gas leaving the fluidized-bed reactor can also pass through a down pass containing heat transfer surfaces.

Disclosed in more particular embodiments are systems, comprising: a fluidized-bed reactor in which carrier particles are reduced; a hydrogen reactor with a steam inlet, in which the reduced carrier particles are oxidized and hydrogen gas is formed; a cooler in which the oxidized carrier particles are cooled; and a silo configured to receive the oxidized carrier particles from the cooler and feed the oxidized carrier particles to the fluidized-bed reactor.

Also disclosed herein are methods for producing hydrogen (H₂) gas, comprising: feeding a fuel into a fluidized-bed reactor, the fluidized-bed comprising carrier particles that are reduced in the fluidized-bed reactor; passing the reduced carrier particles into a hydrogen reactor; and feeding steam into the hydrogen reactor to oxidize the reduced carrier particles and form the hydrogen gas.

In some embodiments, the method may further comprise: passing the oxidized carrier particles from the hydrogen reactor to a cooler; and passing the cooled oxidized carrier particles to a silo that is also configured to feed the oxidized carrier particles to the fluidized-bed reactor.

The fluidized-bed reactor can be fluidized with air, recycled flue gas, oxygen (O₂) gas, or any combination thereof.

In some embodiments, adding the oxidized carrier particles to the fluidized bed causes reduced carrier particles to spill into a hopper upstream of the hydrogen reactor. In particular embodiments, the hopper acts as a storage unit for the oxidized carrier particles, and the method further comprises reheating the reduced carrier particles prior to passing the reduced carrier particles into the hydrogen reactor.

The carrier particles may comprise a metal oxide.

Sometimes, the method can further comprise separating reduced carrier particles from a flue gas leaving the fluidized-bed reactor in a gas-solid separator prior to passing the reduced carrier particles into the hydrogen reactor.

The flue gas leaving the fluidized-bed reactor can pass through a post-combustion gas treatment system to remove contaminants and concentrate the carbon dioxide for sequestration, enhanced oil recovery, or other uses. The carbon dioxide can be removed from the flue gas and concentrated by processes such as amine scrubbing. When the fuel is biomass and the carbon dioxide is sequestered, the entire process can be net negative in carbon dioxide generation.

These and other non-limiting aspects and/or objects of the disclosure are more particularly described below.

### BRIEF DESCRIPTION OF THE DRAWINGS

The following is a brief description of the drawings, which are presented for the purposes of illustrating embodiments disclosed herein and not for the purposes of limiting the same.

FIG. 1 is an illustration of a first example embodiment of a chemical looping system according to the present disclosure.

FIG. 2 is an illustration of a second example embodiment of a chemical looping system according to the present disclosure.

FIG. 3 is an illustration of a third example embodiment of a chemical looping system according to the present disclosure.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.” The term “about” may refer to plus or minus 10% of the indicated number.

It should be noted that many of the terms used herein are relative terms. For example, the terms “inlet” and “outlet” are relative to a direction of flow, and should not be construed as requiring a particular orientation or location of the structure. The terms “upstream” and “downstream” are relative to the direction in which a fluid flows through various components, i.e. the fluid flows through an upstream component prior to flowing through the downstream component. It should be noted that in a loop, a first component can be described as being both upstream of and downstream of a second component. Similarly, the terms “upper” and “lower” are relative to each other in location, i.e. an upper component is located at a higher elevation than a lower component.

The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other.

A fluid at a temperature that is above its saturation temperature at a given pressure is considered to be “superheated.” The temperature of a superheated fluid can be lowered (i.e. transfer energy) without changing the phase of the fluid. As used herein, the term “wet steam” refers to a saturated steam/water mixture (i.e., steam with less than 100% quality where quality is percent steam content by mass). As used herein, the term “dry steam” refers to steam having a quality equal to greater than 100% (i.e., no liquid water is present).

The terms “pipes” and “tubes” are used interchangeably herein to refer to a hollow cylindrical shape, as is commonly understood.

The term “hydrogen gas” is used herein to refer to H₂.

The term “oxygen gas” is used herein to refer to a gas that is greater than 50% 02. For comparative purposes, ambient air usually contains 78% nitrogen (N₂) and 21% 02.

To the extent that explanations of certain terminology or principles of the boiler and/or steam generator arts may be necessary to understand the present disclosure, the reader is referred to Steam/its generation and use, 42nd Edition, edited by G. L. Tomei, Copyright 2015, The Babcock & Wilcox Company, ISBN 978-0-9634570-2-8, the text of which is hereby incorporated by reference as though fully set forth herein.

Traditionally, the chemical energy stored inside hydrocarbons has been released by combustion with gaseous O₂, with CO₂ and H₂O as products. Similar reactions can be carried out if instead of gaseous oxygen, an oxygen carrier particle is used to transport oxygen. Metal oxides such as Fe₂O₃ can act as suitable oxygen carrier particles. The carrier particles are alternately reduced and oxidized. The reduced carrier particles can be reacted with air to generate a heated gas stream to produce steam for electricity generation, or reacted with steam to form a relatively pure stream of hydrogen, which can then be used for a variety of purposes. The present disclosure thus relates to systems and methods for using chemical looping with a fuel source, in conjunction with steam oxidation using metal oxide carrier particles to produce hydrogen gas (H₂). In the present disclosure, the phrases “oxygen carrier particles” and “carrier particles” are used interchangeably.

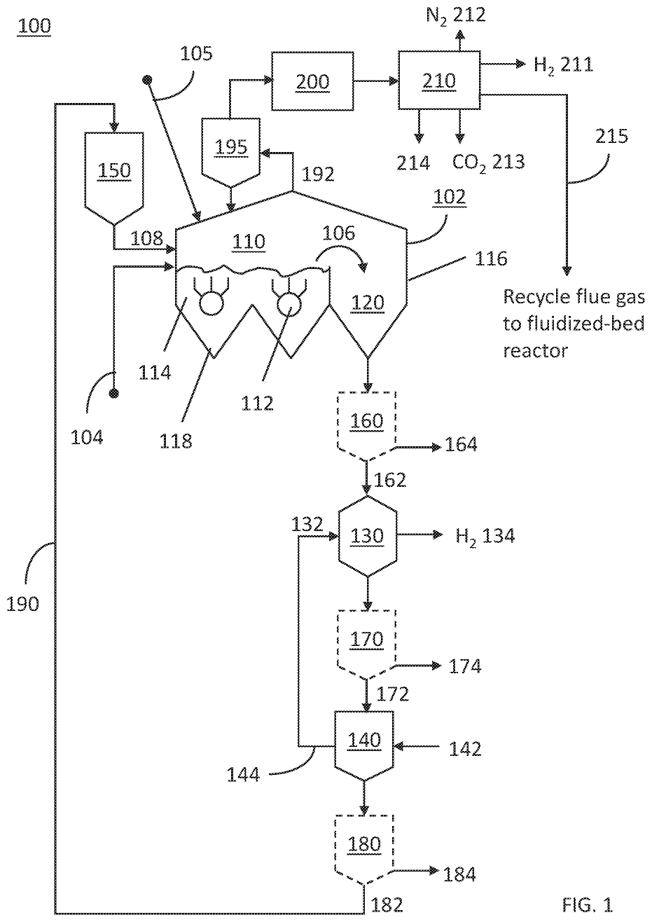

FIG. 1 is a first embodiment of the systems of the present disclosure, and can also be used to explain the reaction sequence known as chemical looping. Chemical looping is a process by which combustion of a carbon-based fuel occurs in two or more steps.

Initially, discussion of the system 100 of FIG. 1 begins at the furnace 102, which is an enclosure containing a fluidized-bed reactor 110. A fuel source 104 is fed to the fluidized-bed reactor. The bed material is particles, such as oxidized carrier particles 108 from silo 150.

The fuel source 104 can comprise a solid, liquid, or gaseous, carbon-based fuel. Examples of carbon-based fuels include, but are not limited to, biomass, waste biomass, biochar, coal, coal char, petroleum coke, oil, oil shale, oil sands, methane-rich gases, and/or fuel-rich waste gases from fuel cells, etc. If a solid or liquid fuel is used, it can optionally be gasified beforehand, for example through pyrolysis, evaporation, partial oxidation, hydrogenation, etc. with carbon dioxide, steam, oxygen, or a combination of these techniques.

In various additional embodiments of the present disclosure, an oxygen-rich source, such as air or oxygen gas (02), can be used to oxidize reduced carrier particles prior to use as bed material.

In particular embodiments, the fluidized-bed reactor 110 is a bubbling fluidized-bed reactor. Such a reactor includes a bed formed from a stacked height of the carrier particles. A fluidization gas distribution grid, such as an open bottom system or a flat floor system, is located beneath the bed of carrier particles. An open bottom system is characterized by widely spaced distribution ducts on which are mounted bubble caps 112 for distributing fluidizing gas (typically air, recycled flue gas, or oxygen gas or any combination of air or oxygen and recycled flue gas) under pressure to fluidize the bed. In a flat floor system, the distribution ducts form the floor of the reactor. At sufficient gas velocities, the solid carrier particles exhibit liquid-like properties. In other embodiments, the fluidized-bed reactor 110 is a circulating fluidized-bed reactor. A circulating fluidized-bed reactor typically also includes a particle separator to remove entrained particles from the flue gas and return them to the circulating fluidized-bed reactor. A fluidized-bed reactor offers an advantage over moving-bed reactors of more intimate contact between the fuel and the oxygen carrier particles.

In FIG. 1, the fluidized-bed reactor includes a bubbling bed 114 onto which fuel is delivered. The fluidized-bed is formed from the carrier particles. A gas-tight furnace flue may include gas-tight tube walls 116 made up of tubes through which water flows to cool the walls. A fluidizing gas, such as air, recycled flue gas, oxygen gas, or a combination thereof, is introduced into the bubbling bed 114 through ducts and spaced-apart bubble caps 112. Additional air or oxygen injection above the dense bed region may also occur, as indicated by reference number 105. This is variously known as Over-Fire Air (OFA) or secondary air or tertiary air. Noncombustible material and ash move downwards and can be removed through bottom hoppers 118. Heat from combustion on the fluidized bed 114 heats water in the wall tubes 116 which may drive a steam generator or other useful work. In some embodiments, water in the tube walls flows in a closed-loop recirculation path (usually including a make-up water line). It is contemplated that the furnace includes additional features such as thermal insulation material, an outer casing, appropriate inlets/outlets for the fuel or other materials, sensors, and so forth.

In the fluidized-bed reactor, combustion with the carbon-based fuel causes the oxidized carrier particles 108 to be reduced. The reduction reaction can be generally expressed as:

$${MO}_{p} + {C}_{x} {H}_{y} \to {MO}_{q} ( q < p ) + {xCO}_{2} + y / 2 {H}_{2} O$$

where CₓH_{y} represents a carbon-based fuel, MOₚ is the metal oxide at its highest oxidation state, and MO_{q} is the metal oxide at a reduced oxidation state, where the condition q<p holds. One aspect of this reduction reaction is that the metal oxide does not have to be completely reduced (q=0). A metal oxide having multiple oxidation states only needs to be reduced sufficiently to enable the production of hydrogen in the downstream hydrogen generation step by the passing of steam through a moving bed packed bed of the partially-reduced metal oxide particles. Besides combustion, highly reducing gases are also passing through the bed and will also reduce the carrier particles.

In some embodiments, the bed is deeply staged (i.e. operated at low stoichiometry) to promote reduction of the particles. The drain rate of the particles may be sufficiently fast (e.g. ˜10% to 30%) to ensure the particles do not spend long enough time in the presence of the incoming fluidizing gas to re-oxidize. A typical residence time for particle reoxidation may be around 10 minutes. For example, using iron as an example of a carrier particle, the oxidized carrier particles may be in the form of, for example, FeO or Fe₂O₃. In the fluidized-bed reactor, using methane (CH₄) as the hydrocarbon, the following non-limiting chemical reactions or combination of these reactions may occur on the fluidized bed:

4Fe₂O₃+CH₄→8FeO+CO₂+2H₂O

FeO+CH₄→Fe+CO+H₂

4FeO+CH₄→4Fe+CO₂+2H₂O

FeO+CH₄→CO+2H₂+Fe

CH₄+H₂O→CO+3H₂

CH₄+3CO₂→CO+2H₂O

Fe₂O₃+CO→2FeO+CO₂

Fe₂O₃+H₂→2FeO+H₂O

FeO+CO→Fe+CO₂

FeO+H₂→Fe+H₂O

Continuing in FIG. 1, it is contemplated that oxidized carrier particles 108 can be added from the silo 150 into the fluidized bed 114. The increase in bed level will cause reduced carrier particles 106 to spill over into a collection hopper 120, which receives the reduced carrier particles. The collection hopper 120 is illustrated here as being within the furnace 102, but could also be located outside the furnace. More generally, the collection hopper 120 can be described as being located downstream of the fluidized-bed reactor 110, and/or upstream of the hydrogen reactor 130.

The reduced carrier particles may be in the form of, for example, Fe or FeO or Fe₃O₄. In this regard, it is noted that the terms “oxidized carrier particles” and “reduced carrier particles” are relative to each other, and do not require the carrier particles to have any specific oxidation state. Rather, the reduced carrier particles in the aggregate have a lower oxidation state compared to the oxidized carrier particles in the aggregate. It may be preferable that the oxygen carrier particles are not fully reduced when they enter the hydrogen reactor, so as to reduce the risk of coke or carbon formation on the surface of the particles, which can deactivate the particles. The temperature of the reduced carrier particles exiting the fluidized-bed reactor may be from about 800° C. to about 1100° C. The oxygen carrier particles may also perform a secondary function as a heat carrier since the sensible heat of the carrier particles can also be used to provide heat for further chemical reactions.

Next, the reduced carrier particles pass into a hydrogen reactor 130. The hydrogen reactor can be described as downstream of the fluidized-bed reactor 110, and as downstream of the collection hopper 120. In the hydrogen reactor, the reduced carrier particles are oxidized in a reaction with steam back to a higher oxidation state, resulting in the formation of hydrogen gas (H₂). A steam inlet line 132 is illustrated entering a steam inlet of the hydrogen reactor, along with a hydrogen outlet line 134 that engages a hydrogen outlet of the hydrogen reactor. This reaction can be expressed as:

$${MO}_{q} + {H}_{2} O ( steam ) \to {H}_{2} + {MO}_{p} ( q < p )$$

The oxidation reaction produces a relatively pure stream of wet hydrogen gas which can then be captured, dewatered, and used in a variety of ways as will be explained in greater detail below.

Again, using iron as an example of a carrier particle, the oxidized carrier particles may be in the form of, for example, Fe or FeO or Fe₃O₄. In the hydrogen reactor, the following chemical reactions may occur:

Fe+H₂O→FeO+H₂

3FeO+H₂O→Fe₃O₄+H₂

The oxidizing hydrogen generation reactions are exothermic, so little to no additional heat needs to be supplied to the hydrogen reactor. The oxygen carrier particles may leave the hydrogen reactor at a higher temperature than when they entered. Since the steam re-oxidizes the oxygen carrier particles, the particles leave the hydrogen reactor at a higher oxidation state than when they entered. It is not necessary to fully oxidize the carrier particles with the steam; it is sufficient to return the carrier particles to the fluidized-bed reactor at a high enough oxidation state so that they can be reduced again, and the hydrogen generation rate can be sustained. In preferred embodiments, the hydrogen reactor is a counter-current moving-bed reactor. Alternatively, the hydrogen reactor may be a bubbling fluidized-bed reactor, with the steam serving as the fluidizing gas.

In some embodiments, the oxidized carrier particles may then pass to a cooler 140. The cooler can be described as being downstream of the hydrogen reactor 130. In the cooler, heat exchange occurs to recover energy and lower the temperature of the carrier particles. A water inlet line 142 is illustrated entering a water inlet, along with a steam outlet line 144 engaging a steam outlet. In some particular embodiments, the steam outlet line from the cooler is used as the steam inlet line 132 to the hydrogen reactor 130. The carrier particles are then returned from the cooler 140 to the silo 150 via riser 190 to begin the cycle again. In this regard, then, the cooler can also be described as upstream of the silo 150. The silo can be described as downstream of the cooler 140, and/or as upstream of the fluidized-bed reactor 110. The carrier particles may be returned through the riser pneumatically by air or steam to the fluidized-bed reactor.

The carrier particles themselves generally include a metal or metal oxide. Any metal oxide or combination thereof may be used so long as the carrier particle is able to undergo a redox reaction. In particular embodiments, the carrier particles are in the form of a robust porous ceramic composite containing the metal/metal oxide. Such a composite can be used repeatedly in redox chemical looping reactions with little or no decrease in activity or oxygen carrying capacity. In particular embodiments, the metal or metal oxide is iron or iron oxide, and the ceramic material may include a substrate of titanium oxide (TiO₂), aluminum oxide (Al₂O₃), and/or calcium oxide (CaO). Other reaction promoters or catalysts may also be present in the carrier particle. The carrier particles may have any shape, and may have a particle size of from about 50 micrometers (μm) to about 2 millimeters (mm). In particular embodiments, the carrier particles have a narrow size distribution around 1500 micrometers. This aids in ensuring low pressure drop through the hydrogen reactor, and in separating the carrier particles from fine ashes in the fluidized-bed reactor.

Continuing, due to their relatively large size, the carrier particles may be easily separated from ash and other combustion products using a particle size separator that separates particles based on their size. This separation can occur at any desired point, and is shown in FIG. 1 in three different locations, which are located downstream of the fluidized-bed reactor 110, or are located downstream of the collection hopper 120.

The first location is between the collection hopper 120 and the hydrogen reactor 130, and is illustrated as particle size separator 160, which produces a large particle stream 162 and a small particle stream 164. The second location is between the hydrogen reactor 130 and the cooler 140, and is illustrated as particle size separator 170. This separator produces a large particle stream 172 and a small particle stream 174. The third location is between the cooler 140 and the silo 150, and is illustrated as particle size separator 180. This separator produces a large particle stream 182 and a small particle stream 184. The terms “large” and “small” are relative to each other, and it is intended that carrier particles of the desired size exit through the large particle stream of the particle size separator and stay within the loop. The materials that exit via the small particle stream are captured for reprocessing or disposal as appropriate.

Referring back to the furnace 102, a flue gas 192 is generated from the fluidized-bed reactor during the reduction reaction in the fluidized bed and the additional air or oxygen injection 105 which completes the fuel conversion. The term “flue gas” is used herein to refer to the products of combustion from the fluidized bed The flue gas may contain carbon monoxide, carbon dioxide, water vapor, and/or hydrogen gas (H₂), as well as other contaminants, such as sulfur dioxide and potentially some smaller solid particles which are entrained in the flue gas. The flue gas can be further processed to remove the contaminants and concentrate the carbon dioxide for sequestration, enhanced oil recovery or other use.

For example, when the fluidized-bed reactor is a circulating fluidized-bed reactor, the flue gas may pass through a particle-gas separator 195, to remove the relatively large oxygen carrier particles from the flue gas and return them to the fluidized-bed reactor. Alternatively, flue gas may also pass through a water-gas shift unit 200, in which carbon monoxide and water are reacted to form carbon dioxide and hydrogen according to the following equation:

$$CO + {H}_{2} O \to {CO}_{2} + {H}_{2}$$

It should be noted this is not expected to be a significant source of hydrogen.

The resulting gas stream, which is further enriched with hydrogen gas, may then pass through a gas separation unit 210 for separating the various gases from each other. Various gas separation methods can be used, including membrane separation, cryogenic distillation, and pressure swing adsorption. Amine scrubbing is another process that can be used to separate the carbon dioxide from the flue gas stream and concentrate it as a gas stream.

As illustrated here, resulting gas streams may include those for hydrogen (H₂) 211, nitrogen (N₂) 212, carbon dioxide (CO₂) 213, and other contaminants/impurities 214. These gas streams can be captured and used/processed as appropriate. For example, the H₂ stream 211 can be combined with the H₂ stream 134 from the hydrogen reactor. The CO₂ stream can be sent for carbon capture/sequestration. The N₂ stream can be vented. Flue gas can also be recycled to the fluidized bed, as indicated by line 215. Such recycling can enhance performance of the combustion process, reduce nitrogen oxide formation, in maintain good fluidization, and maintain a reduced oxygen environment in the bed for reducing the oxygen carrier particles.

In another embodiment, oxygen enhanced combustion is employed in the fluidized bed, in which pure oxygen is mixed with recycled flue gas to provide the fluidizing gas and to provide oxygen for the reaction in the fluidized bed which converts the carbon-bearing fuel and provides the heat required for the endothermic reduction reaction of the oxygen carrier particles. One advantage of this method is that the nitrogen has been eliminated from the recycled flue gas and there is no need for a post-combustion carbon dioxide removal process such as amine scrubbing.

The particle-gas separator 195, water-gas shift unit 200, and gas separation unit 210 can also be considered as being downstream of the fluidized-bed reactor 110. It is noted that these components are used to process flue gas leaving the fluidized-bed reactor. For example, the gas separation unit can be an amine scrubber for removal and concentration of carbon dioxide. In contrast, the hydrogen reactor 130, cooler 140 and the silo 150 are used to process the carrier particles leaving the fluidized-bed reactor.

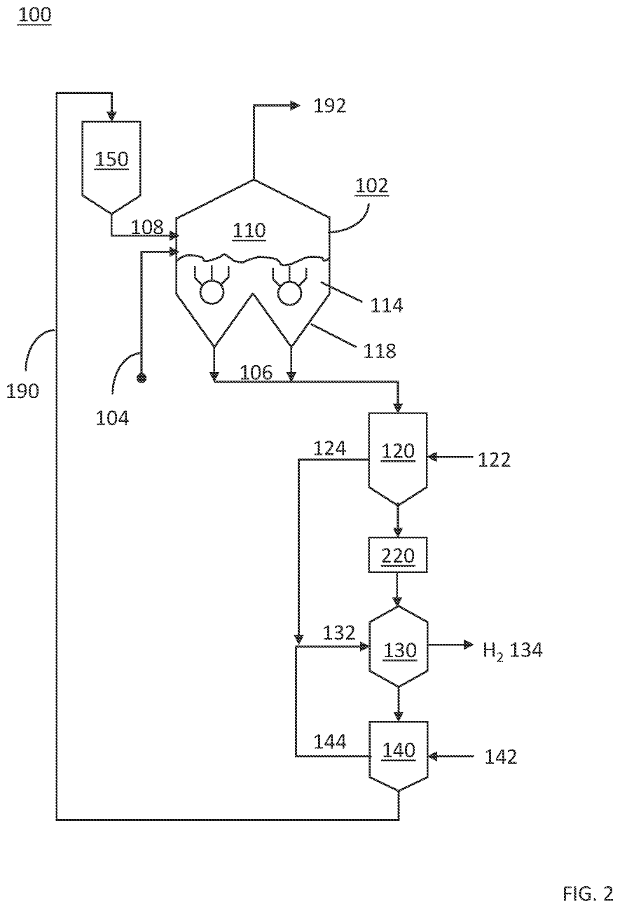

A second example embodiment of a system of the present disclosure is illustrated in FIG. 2. This embodiment also includes fluidized-bed reactor 110, collection hopper 120, moving-bed hydrogen reactor 130, or alternatively, fluidized-bed reactor and cooler 140. Flue gas 192 is generated and may be processed as described in FIG. 1. The operation of the system is similar to that described in FIG. 1, with some of the following differences.

In FIG. 2, the fluidized bed reactor 110 is located within the furnace 102, but the collection hopper 120 is outside of the furnace. Reduced carrier particles 106 exit the fluidized bed reactor through the bottom hoppers 118 and flow into the collection hopper 120, for example via bed drain conveyor. The collection hopper can act as a storage container for the carrier particles prior to their passing into the hydrogen reactor 130. One advantage of this arrangement is that the oxygen carrier particles entering the collection hopper are more consistently reduced. Again, it is not necessary to fully reduce the carrier particles.

In preferred embodiments, the carrier particles are not cooled prior to passing into the hydrogen reactor 130. Desirably, the carrier particles have a temperature of about 800° C. or higher, to increase the speed of the hydrogen generation reaction, i.e., sufficiently fast kinetics. If it is desired to cool the carrier particles, the carrier particles may cool off passively or be actively cooled within the collection hopper 120. In this illustration, active cooling is performed by a water inlet line 122 entering a water inlet, along with a steam outlet line 124 engaging a steam outlet. In some particular embodiments, the steam outlet line from the collection hopper/storage container is used as the steam inlet line 132 to the hydrogen reactor 130. This embodiment provides an alternate way to generate steam in the hydrogen reactor, to complement the steam generation in the rest of the boiler system.

Because the carrier particles may be cooler than needed (e.g., <750° C.) for proper function in the hydrogen reactor, a heater 220 may be placed downstream of the collection hopper 120 and upstream of the hydrogen reactor 130 for reheating the carrier particles prior to their passage into the hydrogen reactor. The heater may be an electric resistance or induction heater.

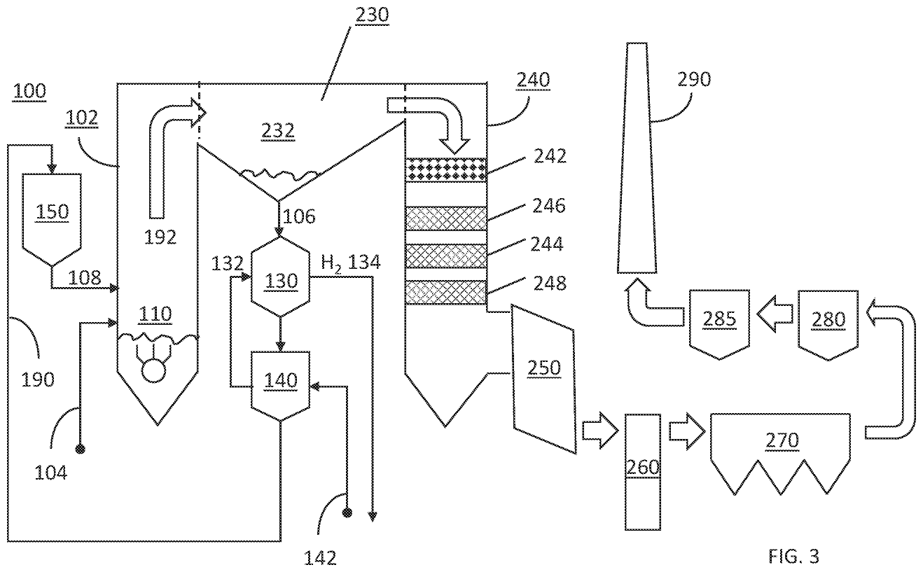

A third example embodiment of a system of the present disclosure is illustrated in FIG. 3. Here, the furnace 102 is illustrated in the form of a boiler that also includes a horizontal convection pass 230 and a down pass 240. Besides producing hydrogen gas, this system also produces steam which can be used for various applications as well. This is also an illustration of how an existing system can be retrofitted to produce hydrogen gas as well, with the addition of some extra components.

The walls of the furnace 102 are typically formed from gas-tight tube walls or membrane walls formed by tubes with membrane disposed between and welded to the tubes, to provide a seal against leakage of flue gas. These tubes absorb heat energy, and may be designed to carry water and wet steam (i.e., a steam/water mixture, or equivalently, steam quality less than 100%), or can be designed to carry superheated steam having a steam quality of 100% (i.e., no liquid component), as desired. Again, a fuel source 104 feeds the fluidized-bed reactor 110, along with oxidized carrier particles 108 from silo 150. The reactor may be operated sub-stoichiometrically to produce a reducing environment that reduces the carrier particles, which are subsequently entrained in the flue gas 192.

The horizontal convection pass 230 includes a gas-solid separator 232, which is used to separate the reduced carrier particles that are entrained in the flue gas. Examples of such gas-solid separators may include U-beams, a hot cyclone, or other suitable devices.

The reduced carrier particles then pass or are fed to the hydrogen reactor 130, where they are oxidized and produce hydrogen gas. The carrier particles then continue to the cooler 140, and are then returned to the silo 150 via riser 190. Water inlet line 142, hydrogen outline line 134, and steam outlet/inlet line 132 are also shown.

The flue gas 192 continues into the down pass 240, where combustion is completed. For example, the down pass can include an Over-Fire Air (“OFA”) zone 242 to limit the formation of nitrogen oxides (NOₓ). The down pass can also include heat transfer surfaces/components for recovering heat energy, such as a primary superheater (PSH) 244, a secondary superheater (SSH) 246, and/or an economizer 248. The superheaters increase the steam quality, and the economizer preheats water which is subsequently used in the furnace.

Additional processing of the flue gas may occur, if desired. For example, the flue gas may then enter a selective catalytic reduction (SCR) system 250 to remove nitrogen oxides (NOₓ) from the flue gas. The flue gas can pass through an air preheater 260 to further cool the flue gas and preheat the air entering the furnace 102. The flue gas can pass through a particulate collection device 270 to remove additional particles. Examples of particulate collection devices may include an electrostatic precipitator (ESP) or a baghouse. The flue gas can also pass through a flue gas desulfurization (FGD) system 280 to remove contaminants such as sulfur dioxide (SO₂), sulfur trioxide (SO₃), HCl, or other acid gases. The FGD system may be a wet system or a dry system, as desired. The cleaned flue gas can then be sent for further treatment to capture the CO₂ for sequestration or other uses, as indicated by reference numeral 285. For example, the flue gas can be passed through a post-combustion carbon dioxide scrubbing system to remove and concentrate the carbon dioxide. In other embodiments, the volume of flue gas that needs to be treated can be reduced by using oxygen substitution (oxy-combustion) in the fluidized bed to eliminate the nitrogen in the flue gas. The flue gas may then be sent to a stack 290.

In some embodiments, the systems of FIGS. 1-3 can be operated under pressure, i.e. greater than atmospheric pressure. In some other embodiments, the systems can be operated in an oxygen-rich environment (i.e. greater oxygen content compared to air). Some components are only described in one figure, but should be considered as being applicable to the systems of the other figures as well. Other components (e.g. steam drum, downcomer, attemperator, reheater, pumps, valves, sensors) may also be present, but are not depicted here.

The systems and methods of the present disclosure provide useful alternatives to traditional chemical looping systems. They can handle challenging fuels (e.g. waste, biomass, etc.) that may cause high degrees of particle fouling, agglomeration, and higher attrition/make-up rates. The systems can reduce the carrier particles to a low enough oxidation state to be able to make hydrogen gas (H₂) effectively.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A system, comprising:
a fluidized-bed reactor in which carrier particles are reduced; and
a hydrogen reactor with a steam inlet, in which the reduced carrier particles are oxidized and hydrogen gas is formed.

2. The system of claim 1, further comprising a silo configured to feed the oxidized carrier particles to the fluidized-bed reactor.

3. The system of claim 1, further comprising a cooler in which the oxidized carrier particles are cooled.

4. The system of claim 3, wherein the cooler produces steam that is fed to the steam inlet of the hydrogen reactor.

5. The system of claim 1, further comprising a hopper upstream of the hydrogen reactor, which is adapted to receive the reduced carrier particles from the fluidized-bed reactor.

6. The system of claim 5, wherein the fluidized-bed reactor and the hopper are located within a furnace.

7. The system of claim 5, further comprising a heater downstream of the hopper and upstream of the hydrogen reactor, which is adapted to reheat the reduced carrier particles.

8. The system of claim 1, wherein the fluidized-bed reactor is a bubbling fluidized-bed reactor or a circulating fluidized-bed reactor.

9. The system of claim 1, wherein a flue gas from the fluidized-bed reactor passes through a water-gas shift unit and a pressure-swing adsorption unit to produce another hydrogen stream.

10. The system of claim 1, further comprising a gas-solid separator for separating reduced carrier particles entrained in a flue gas leaving the fluidized-bed reactor, wherein the reduced carrier particles pass to the hydrogen reactor.

11. The system of claim 1, wherein the gas-solid separator comprises u-beams or a cyclone.

12. The system of claim 1, wherein a flue gas leaving the fluidized-bed reactor passes through a down pass containing heat transfer surfaces.

13. An apparatus, comprising:
a fluidized-bed reactor in which carrier particles are reduced;
a hydrogen reactor with a steam inlet, in which the reduced carrier particles are oxidized and hydrogen gas is formed;
a cooler in which the oxidized carrier particles are cooled; and
a silo configured to receive the oxidized carrier particles from the cooler and feed the oxidized carrier particles to the fluidized-bed reactor.

14. A method for producing hydrogen (H₂) gas, comprising:
feeding a fuel into a fluidized-bed reactor, the fluidized bed comprising carrier particles that are reduced in the fluidized-bed reactor;
passing the reduced carrier particles into a hydrogen reactor; and
feeding steam into the hydrogen reactor to oxidize the reduced carrier particles and form the hydrogen gas.

15. The method of claim 14, further comprising:
passing the oxidized carrier particles from the hydrogen reactor to a cooler;
passing the cooled oxidized carrier particles to a silo that is also configured to feed the oxidized carrier particles to the fluidized-bed reactor.

16. The method of claim 14, wherein the fluidized-bed reactor is fluidized with air, recycled flue gas, or oxygen (O₂) gas, or a combination thereof.

17. The method of claim 14, wherein adding the oxidized carrier particles to the fluidized bed causes reduced carrier particles to spill into a hopper upstream of the hydrogen reactor.

18. The method of claim 17, wherein the hopper acts as a storage unit for the oxidized carrier particles, and the method further comprising:
reheating the reduced carrier particles prior to passing the reduced carrier particles into the hydrogen reactor.

19. The method of claim 14, wherein the carrier particles comprise a metal oxide.

20. The method of claim 14, further comprising separating reduced carrier particles from a flue gas leaving the fluidized-bed reactor in a gas-solid separator prior to passing the reduced carrier particles into the hydrogen reactor.

21. The system of claim 1, wherein the hydrogen reactor is a moving-bed reactor or a fluidized bed reactor that uses steam as a fluidizing gas.

22. The method of claim 14, wherein the hydrogen reactor is a moving-bed reactor or a fluidized bed reactor that uses steam as a fluidizing gas.

23. The method of claim 14, further comprising returning oxidized carrier particles to the fluidized-bed reactor pneumatically using air.
